(19) United States
(12) Patent Application Publication
(10) Pub. No.: US 2013/0014677 A1
(43) Pub. Date: Jan. 17, 2013

(54) DEVICE FOR LIFTING AND LOWERING

(71) Applicant: Veli-Matti Ilari Jussila, Lempaala (FI)

(72) Inventor: Veli-Matti Ilari Jussila, Lempaala (FI)

(73) Assignee: VELVISION OY, Tampere (FI)

(21) Appl. No.: 13/577,074

(22) PCT Filed: Feb. 4, 2011
(86) PCT No.: PCT/FI11/00006

§ 371 Date: Oct. 1, 2012

(30) Foreign Application Priority Data
Feb. 5, 2010 (FI) 20100042

(51) Int. Cl. B66F 7/14; B66F 3/10; A47B 9/00

(52) U.S. Cl. 108/147; 254/102

(57) ABSTRACT

Lifting/lowering apparatus comprises a lower frame (1), a horizontal upper frame (7) supported by which a plane is adjusted and comprises a lifting mechanism adjusted between the mentioned lower frame and upper frame with the help of which lifting mechanism the upper frame (7) can be lifted and lowered in relation to the lower frame (1) and that the lifting mechanism comprises adjacent pillars (2, 3, 4), each pillar is formed of cylinder parts (2-4) that can be moved telescopically in relation to each other which cylinder parts are attached to each other by threads such that the rotation of the parts (2-4) in relation to each other changes the height of the pillars. In order to reduce the construction weight the cylinder parts (2-4) are made of plastic and in order to improve the receiving of the sideway loadings the inner diameter of the cylinder part (4) having the smallest diameter is over 200 mm.

The invention relates to a lifting/lowering apparatus, such as to a plane that can be lifted, a table or a lifting platform construction, equipped with at least two adjacent lifting mechanism that can be extended telescopically which lifting/lowering apparatus comprises a lower frame, further a horizontal upper frame supported by which a plane, such as a working plane is adjusted and comprises a lifting mechanism adjusted between the mentioned lower frame and upper frame with the help of which lifting mechanism the upper frame can be lifted and lowered in relation to the lower frame and that the lifting mechanism comprises adjacent pillars in which case each pillar is formed of cylinder parts that can be moved telescopically in relation to each other which cylinder parts are attached to each other with the help of threads in such a way that the rotation of the parts in relation to each other changes the height of the mentioned pillars.

Previously for example lifting platform constructions are known as lifting/lowering apparatuses in which lifting platform constructions a vertical mast is adjusted on top of the base. The lifting platform is being moved supported by the mast at the side of the mast up and down. The mast can additionally be supported at its upper end to the building next to which it is installed. The removal of this kind of lifting platform next to the building to another location is difficult because the supports of the mast must be opened. Often also because of the blocks at the removal line the mast must be dismantled, too.

Further lifting platforms, so called articulated platforms attached on top of the base are known which articulated platforms have a lifting apparatus consisting of articulated arms having a articulated form. The disadvantage of these is a fairly high starting height of the platform, or the lowest position that is usually about 2 metres regarding such articulated platforms with which one can reach the height of 8-10 metres. The disadvantage of the articulated platforms is also the weight of the articulated mechanism which weight lifts the centre of gravity of the construction fairly high when the platform is being lifted in which case the loading of the platform must be focused mainly only to its centre line.

Also working platforms that can be moved supported by the lifting booms are known in which case these working platforms are relatively small lifting cages that can be loaded lightly, for example they are meant only for two persons. The advantage of these compared to the other platforms is the greater moving distance in all sideways, but the disadvantage is the small size of the lifting cage and limited loading capacity and the space required at each time by the lifting booms in sideways and which space is needed in several sideways, too.

Previously a lifting platform construction according to the above mentioned preamble is known also from a Chinese publication CN 2809309Y. In this construction the telescopic parts are made of metal and they are considerably heavy. In order to avoid the excessive increase of the weight, the telescopic parts have diameters that are as small as possible. Due to this the individual pillar or even two parallel pillars consisting of them cannot handle the sideway forces directed to the upper frame at least at their uppermost position.

With the help of a lifting/lowering apparatus according to the invention unexpected improvements can be achieved to the existing prior art and it is characteristic of the invention that in order to reduce the construction weight the cylinder parts are made of plastic and in order to improve the receiving of the sideway loadings, the inner diameter of the cylinder part having the smallest diameter is over 200 mm.

The advantage of the invention is the fact that the lifting mechanism will need a little space, will be light and will resist the weather. In addition to the lifting mechanism no other constructions conveying power are needed between the lower frame and the upper frame. With the help of the sizing of the cylinder parts belonging to the lifting mechanism, cylinders in question can be made to receive all the vertical and sideway loadings in question. The lifting mechanism includes only simple parts and the rotating of them. If for example a working platform is being lifted with the lifting mechanism, the platform can easily be made to have a length of several metres, at least over 6 m and to have a width of over 2 m.

In the following the invention is described more detailed by referring to the accompanying drawings in which

FIG. 1 shows a lifting/lowering apparatus according to the invention as a side view.

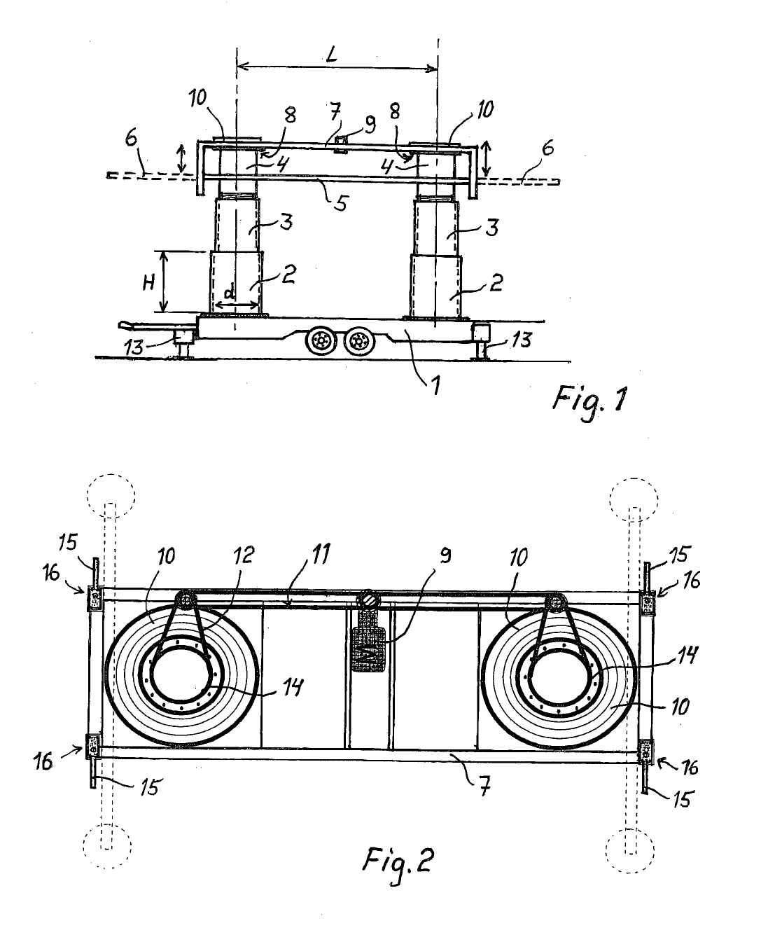

FIG. 2 shows the upper frame of the construction seen from above.

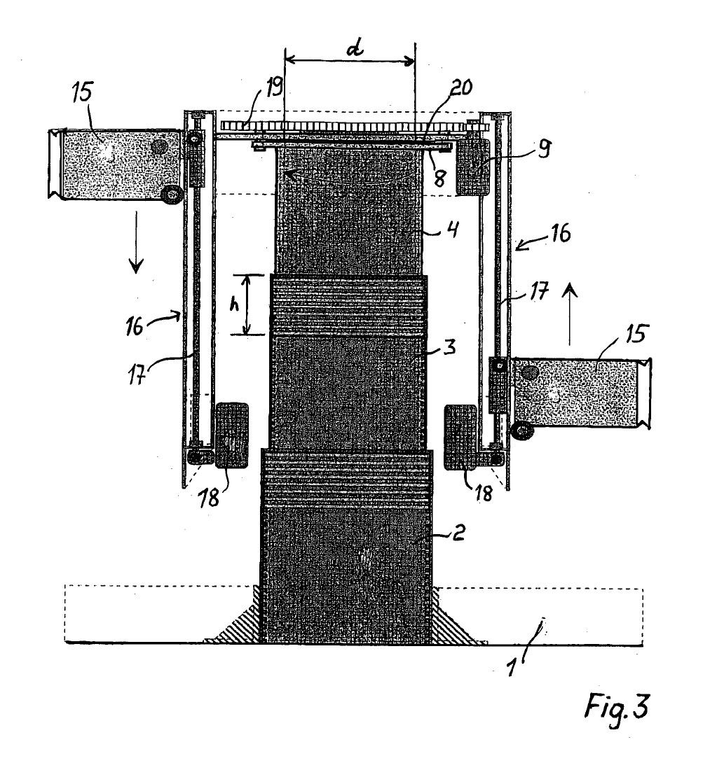

FIG. 3 shows the construction seen from the end.

In the FIG. 1 a lifting platform unit built on top of a towed base 1 equipped with wheels supported by pillars 2, 3, 4 made of plastic material and can be extended telescopically and that are located at a distance L from each other is shown as an example. The upper frame 7 of the lifting platform is supported only by the pillars. The parts 2-4 of the pillars are attached to each other with a thread and one implementation form is such that the inner part of each part 2 and 3 is completely full of threads and the outer surface of each part 3 and 4 has threads at least at the lower part. When the lowest parts 2 are attached to the base 1 in a non rotating way, only parts 3 and 4 will be rotated during the lifting and lowering of the upper frame 7. Each thread part has preferably the same pitch per a cycle. The uppermost rotating part 4 is also a cylinder made of plastic and has an inner diameter that is over 250 mm. With this diameter dimensioning it is ensured that the wall thickness of the cylinder parts 2-4 stays moderate, for example under 30 mm and that the cylinder parts 2-4 also resist the side forces directed to them. The ratio of the inner diameter d of the cylinder parts 2-4 to the height H is most advantageously between ½-¼. Lightness can be reached with the help of plastic materials used as base material of the cylinder parts 2-4, the density of which plastic materials is 1.4 kg/dm3 or under it. The base 1 of the lifting platform is supported by adjustable feet 13 known as such.

Parts 3 and 4 are rotated with the help of a rotating motor 9 located at the upper frame 7. There is a flange at the upper edge of the parts 4. The upper frame 7 rests supported by this flange equipped with bearings in such a way that the part 4 and the flange of its upper part can rotate between the counter-flanges belonging to the upper frame 7. The working platform 5 is advantageously adjusted separately at the both sides of the unit. These platforms 5 can be lifted and lowered in relation to the upper frame 7 with the help of their own lifting motors. It is advantageous for this construction that when the upper frame 7 is lowered to its lowest position, the working platform 5 can be lowered with the help of the lifting apparatuses 16 located at the sides even till the ground surface for loading.

In the FIG. 2 the upper frame 7 is shown from above in such a way that the drawing of the rotating motor 9 with the help of belts 11 and 12 moves to both parts 4 through the band pulleys 14. The flanges 10 are the upper, non rotating flanges belonging to the bearing. The rotating is performed only at the uppermost parts 4. Also the part 3 starts to rotate either with the part 4 or the part 4 rotates by itself. There are tools 15, 16 at the corners of the upper frame 7 in order to attach the working platform 5 to the sides of the upper frame 7 and in order to move it in vertical direction in relation to the upper frame 7.

In the FIG. 3 there is a lifting platform construction seen from the end in such a way that the parts 2 and 3 are cut in vertical direction. In the parts 1 and 2 there are threads at the whole inner surface. The part 4 has threads only at the outer surface at its lower part covering the height h. Similarly the part 3 has threads at the outer surface only covering the height h. The rotating of the parts 3 and 4 out of the previous part is prevented for example with the finishing of the inner thread part before the edge border of the part. The rotating of the parts 4 can immediately be conveyed to rotate also the parts 3 till the prevention of the rotation for the part 3 occurs or the parts 4 that rotate first, rotate their whole movement distance and then they start to rotate the part 3. Most advantageously all parts 2-4 have the same pitch of the thread per the same cycle. The threads are easy to manufacture into parts 2-4 when plastic, such as nylon is used as the material of the parts. Trapeze is the most advantageous form of threads.

Working platforms that can be moved in vertical direction are arranged downwards from the upper frame 7 at both sides. These platforms are not shown but they are attached to the parts 15 with a some kind of quick attachment method in which case working planes of various lengths and widths can easily be changed to them, if needed. Attaching parts 15 can be moved with the help of the lifting arrangement 16 that comprises motors 18 and conveyor screws 17. When the lifting mechanism of the upper frame 7 is a telescopic pillar solution according to the invention, it is possible to easily arrange the described arrangements of the working platforms at the both sides of the pillars.

Although a lifting platform construction realized with the help of two pillars is shown in the figures, it is possible to increase the number of the pillars even to four pieces in which case their diameters can be reduced and in spite of that more stability can be gained. Also the number of the parts 2, 3, 4 is not restricted to three but in the solutions according to the invention there can be more of them.

Although a lifting platform construction functioning with the lifting/lowering apparatus according to the invention is shown in the FIGS. 1-3, any lifting and lowering platforms or lifting tables can be implemented with the apparatus according to the invention.

The plastic material of the parts 2-4 is most advantageously polyamide as such or mixed with some known mineral fillers in order to improve the material properties such as in order to reduce friction in the threads or in order to improve weather resistance. Further the plastic material of the parts can be reinforced with known fibre reinforcements, the external surface of the parts can be reinforced with fibres or reinforcement net. Also the surfaces of the threads can be treated or coated with nanotechnology in order to reduce friction.

What is claimed is:

1. A lifting/lowering apparatus, such as a plane that can be lifted, a table or a lifting platform construction, equipped with at least two adjacent lifting mechanisms that can be telescopically extended, which lifting/lowering apparatus comprises a lower frame (1), further a horizontal upper frame (7) supported by which a plane, such as a working plane (5), (6) is adjusted and comprises a lifting mechanism adjusted between the mentioned lower frame and upper frame with the help of which lifting mechanism the upper frame (7) can be lifted and lowered in relation to the lower frame (1) and that the lifting mechanism comprises adjacent pillars (2, 3, 4) in which case each pillar is formed of cylinder parts (2-4) that can be moved telescopically in relation to each other, which cylinder parts are attached to each other with the help of threads in such a way that the rotation of the parts (2-4) in relation to each other changes the height of the mentioned pillars, characterized in that in order to reduce the construction weight the cylinder parts (2-4) are made of plastic and in order to improve the receiving of sideway loadings, the inner diameter (d) of the cylinder part (4) having the smallest diameter is over 200 mm.

2. The lifting/lowering apparatus according to the claim 1, characterized in that the lowermost parts (2) of the pillars are attached to the base (1) in a non rotatable way.

3. The lifting/lowering apparatus according to the claim 2, characterized in that the upper frame (7) comprises a rotating motor (9) with the help of which the rotating parts (3, 4) of the pillars can be rotated.

4. The lifting/lowering apparatus according to the claim 1, characterized in that the lower frame (1) comprises a rotating motor (9) with the help of which the lowest, rotating parts (2, 3) of the pillars can be rotated.

5. The lifting/lowering apparatus according to the claim 1, characterized in that wall thicknesses defined on the grounds of allowed loadings are chosen for the parts (2-4) of the pillars in which case the parts (2-4) of the pillars are meant to receive all allowable vertical and sideway loadings conveyed through the upper frame (7).

6. The lifting/lowering apparatus according to the claim 1, characterized in that the threads of each part (2-4) are equipped with a pitch of equal size per a cycle.

7. The lifting/lowering apparatus according to the claim 1, characterized in that the threads of the parts (2-4) have a profile equal to trapeze threads.

8. The lifting/lowering apparatus according to the claim 1, characterized in that the parts (2-4) are made of polyamide plastic or made of mixed/reinforced polyamide plastic.

9. The lifting/lowering apparatus according to the claim 1, characterized in that the density of the material of the plastic parts (2-4) is under 1.4 kg/dm3.

10. The lifting/lowering according to the claim 1, characterized in that the external surfaces of the parts (2-4) are reinforced with fibre or net reinforcements.
